(19) United States
(12) Patent Application Publication
(10) Pub. No.: US 2015/0320052 A1
(43) Pub. Date: Nov. 12, 2015

(54) REVERSIBLE APPARATUS AND METHOD FOR CREATING COMPOSITE CONVENIENCE FOOD

(71) Applicant: InOvation Enterprises, Inc, Cincinnati, OH (US)

(72) Inventors: Jacqueline H. Diaz, Cincinnati, OH (US); Claude C. Mandeville, JR., Cincinnati, OH (US)

(21) Appl. No.: 14/689,084

(22) Filed: Apr. 17, 2015

Related U.S. Application Data
(60) Provisional application No. 61/990,572, filed on May 8, 2014.

(51) Int. Cl. A21B 3/13; A21D 8/02

(52) U.S. Cl. CPC A21B 3/132; A21D 8/02

(57) ABSTRACT

A reversible mold comprises a pan having a bottom wall and upstanding side walls surrounding the bottom wall to form an outer receptacle. A convex shape formed in a mid-portion of the bottom wall forms an inner receptacle when the pan is inverted. The outer receptacle of the reversible mold is filled with a first edible batter and caused to set by either baking, chilling or freezing to form a firm shell portion. The inner receptacle is subsequently or in another reversible mold is filled with a second edible batter and caused to set by either baking, chilling or freezing to form a firm filler portion that is inserted into a hollow portion of the firm shell portion. Two such filled shell portions can then be assembled to create a convenience food with a contrasting center.

### CROSS-REFERENCE TO RELATED APPLICATION

This application claims priority or the benefit of U.S. Provisional Application 61/990,572, entitled “Reversible Apparatus And Method For Creating Composite Convenience Food” and filed May 8, 2014, the contents of which are fully incorporated herein by reference.

### BACKGROUND OF THE INVENTION

1. Field of the Invention

The field of art disclosed herein pertains to food preparation, and more particularly for molded food items.

2. Description of the Related Art

Convenience food items are made from a molded batter that is made firm by baking, chilling or freezing. Contrasting textures, flavors, or colors can be introduced by mechanically swirling together two different molded batters. Alternatively, convenience food items are assembled by sandwiching layers of firmed, molded batters, such as with ice cream sandwiches. In other instances, a flowable food mixture is injected into an outer food shell, such as in pastries. However, generally-known techniques do not achieve a contrasting center portion of a firm molded batter that is encompassed by an outer shell.

### SUMMARY OF THE INVENTION

In one aspect, the present disclosure provides a reversible mold including a pan having a bottom wall and upstanding side walls surrounding the bottom wall to form an outer receptacle; and including a convex shape formed in a mid-portion of the bottom wall to form an inner receptacle when pan is inverted.

In another aspect, the present disclosure provides a method for forming a convenience food. In one embodiment, the method includes providing at least one reversible mold. With a reversible mold in a non-inverted position, the method includes filling the outer receptacle with a first edible batter, exposing the reversible mold to a first selected temperature range for a first selected period of time to cause the first edible batter to become a firm first shell portion, and removing the firm first shell portion from the reversible mold. With a reversible mold in an inverted position, the method includes filling the inner receptacle with a second edible batter, exposing the reversible mold to a second selected temperature range for a second selected period of time to cause the second edible batter to become a firm first filler portion, removing the firm first filler portion from the reversible mold, and inserting the firm first filler portion into a hollow portion of the firm first shell portion.

These and other features are explained more fully in the embodiments illustrated below. It should be understood that in general the features of one embodiment also may be used in combination with features of another embodiment and that the embodiments are not intended to limit the scope of the invention.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 illustrates a perspective view of a reversible mold in a non-inverted position, according to one embodiment;

FIG. 2 illustrates a side view in vertical cross section of the reversible mold of FIG. 1 in the non-inverted position, according to one embodiment;

FIG. 3 illustrates a perspective view of the reversible mold of FIG. 1 in an inverted position, according to one embodiment;

FIG. 4 illustrates a side view in vertical cross section of the reversible mold of FIG. 3 in the inverted position, according to one embodiment;

FIG. 5 illustrates a side view in vertical cross section of the reversible mold of FIG. 2 in the non-inverted position after filling with a first edible batter, according to one embodiment;

FIG. 6 illustrates a side view in vertical cross section of the reversible mold of FIG. 4 in the inverted position after filling with a second edible batter, according to one embodiment;

FIG. 7 illustrates a side view in vertical cross section of a firm filler portion from the inverted reversible mold of FIG. 6 being inserted into a firm shell portion from the non-inverted reversible mold of FIG. 5, according to one embodiment;

FIG. 8 illustrates the firm filler portion fully inserted into the firm shell portion of FIG. 7 to form half of convenience food item, according to one embodiment;

FIG. 9 illustrates a perspective view of a convenience food item assembled from two halves of FIG. 8, according to one embodiment; and

FIG. 10 illustrates a flow diagram of a method of producing a convenience food item having a contrasting center.

### DETAILED DESCRIPTION

The present innovation relates generally to producing convenience food items, and more particularly to an apparatus and method of forming a firm filler portion that is encased with a firm outer shell portion.

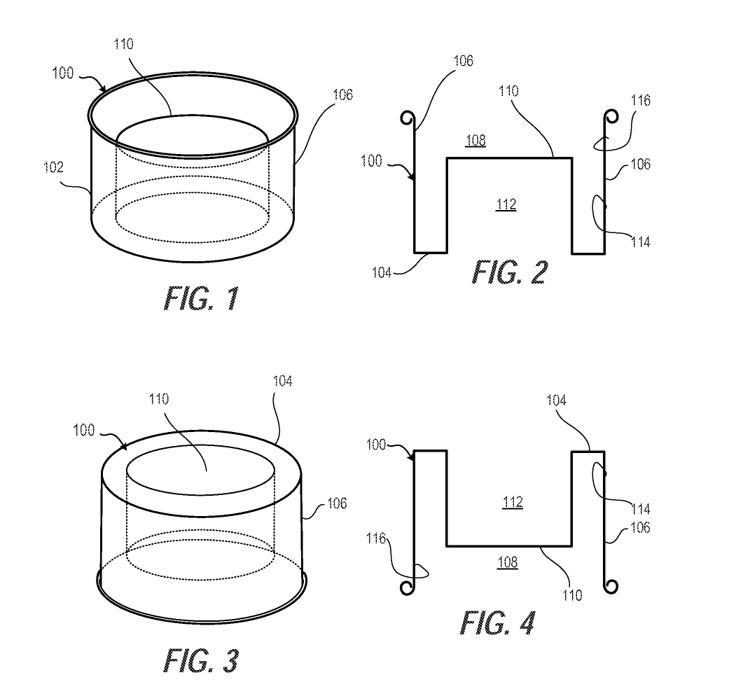

FIGS. 1-4 illustrates a reversible mold 100 in a non-inverted position, according to one embodiment. The reversible mold 100 includes a pan 102 having a bottom wall 104 and upstanding side walls 106 surrounding the bottom wall 104 to form an outer receptacle 108. A convex shape 110 is formed in a mid-portion of the bottom wall 104 to form an inner receptacle 112 when pan 102 is inverted. For clarity, the convex shape 110 is cylindrical. However, other geometric and fanciful shapes may be employed that allow for releasing the contents from the outer receptacle 108 and the inner receptacle 112. In the illustrative embodiment, the convex shape 110 that is cylindrical extends partially into the outer receptacle 108. Thus, the outer receptacle 108 comprises an annular ring portion 114 that surround the convex shape 110 and comprises a cylindrical portion 116 above the convex shape 110 that communicates with the annular ring portion 114.

In one embodiment, the reversible mold 100 is a baking pan. Alternatively or in addition, the reversible mold 100 is a material that is tolerant of refrigeration and freezing. In some constructions, at least at least some portions are made of a durable, light-weight and easy-to-clean material. Suitable construction materials include steel, aluminum (drawn/stamped, spun, hydroformed, metal injection molded, 3-D printed or cast), carbon steel, aluminized steel, laboratory glass, food-safe polymers, silicone, cast iron, glass, ceramic, porcelain, clad metal or any combination thereof as long as it is suitable for placement and baking within an oven. Alternatively or in addition, the reversible mold 100 is constructed of two or more individual pieces that are then placed together to form the appropriate shape and configuration.

In other embodiments, the pan 102 may have other cross-sectional shapes (e.g., square, triangular, hexagonal, oblong, rhomboid, fanciful, etc.) and/or a ratio of the length L to the diameter/width W of each pan 102 may be larger or smaller than ten.

Components of the baking pan assembly preferably are coated, at least where contact is likely with goods to be baked, with one or more non-stick compositions such as TEFLON polytetrafluoroethylene, also known as PTFE.

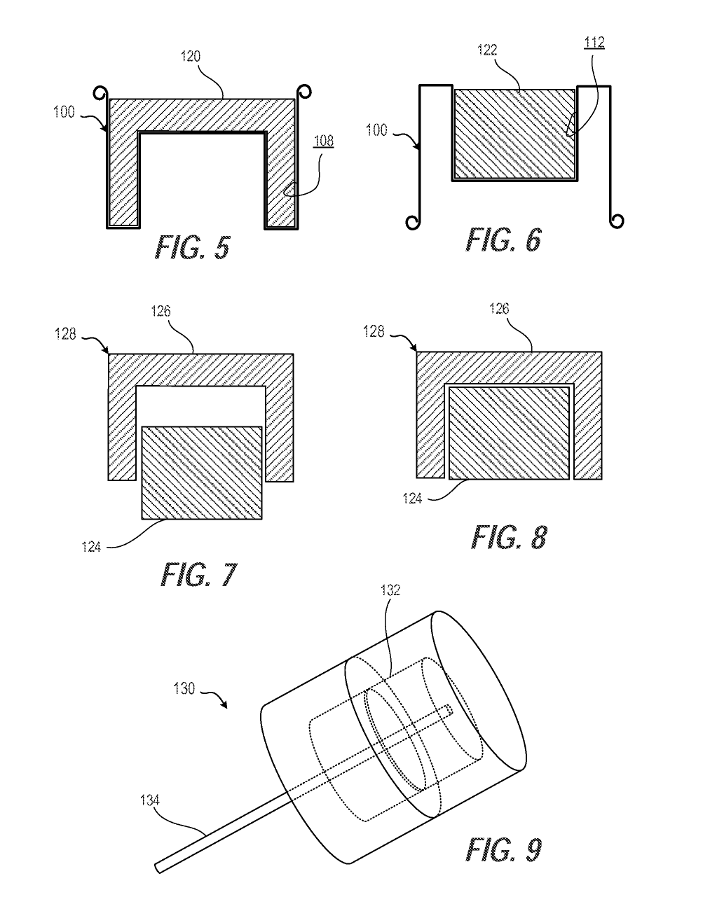

FIG. 5 illustrates the reversible mold 100 in the non-inverted position after filling the outer receptacle 108 with a first edible batter 120, according to one embodiment. The first edible batter 120 can be intended to become firm by baking, setting at room temperature, chilling or freezing.

As used herein, the term “baking” refers to the application of dry heat energy by such methods as convection, conduction, and the like, or application of energy by infrared radiation, electromagnetic radiation, such as microwave energy, and the like. The baking step may be performed using a variety of heating devices. For example, the heating device may be a thermally insulated chamber including but not limited to: earth ovens, ceramic ovens, masonry ovens, solar ovens, convection ovens, reflection ovens, microwave ovens, dutch ovens; and includes ovens heated by gas, electricity, or wood-firing and those used in residential, commercial, or industrial applications.

FIG. 6 illustrates the reversible mold 100 in the inverted position after filling the inner receptacle 112 with a second edible batter 122, according to one embodiment. The second edible batter 122 can be intended to become firm by baking, setting at room temperature, chilling or freezing.

FIG. 7 illustrates assembling a firm filler portion 124 from the inverted reversible mold 100 of FIG. 6 by being inserted into a firm shell portion 126 from the non-inverted reversible mold 100 of FIG. 5, according to one embodiment. FIG. 8 illustrates the firm filler portion 124 fully inserted into the firm shell portion 126 of FIG. 7 to form half of convenience food item 128, according to one embodiment;

FIG. 9 illustrates a convenience food 130 item assembled from two halves of a convenience food item 128 of FIG. 8, according to one embodiment. A full enclosed contrasting center 132 is depicted in phantom. A stick 134 has been asserted for easy handling as food on the go.

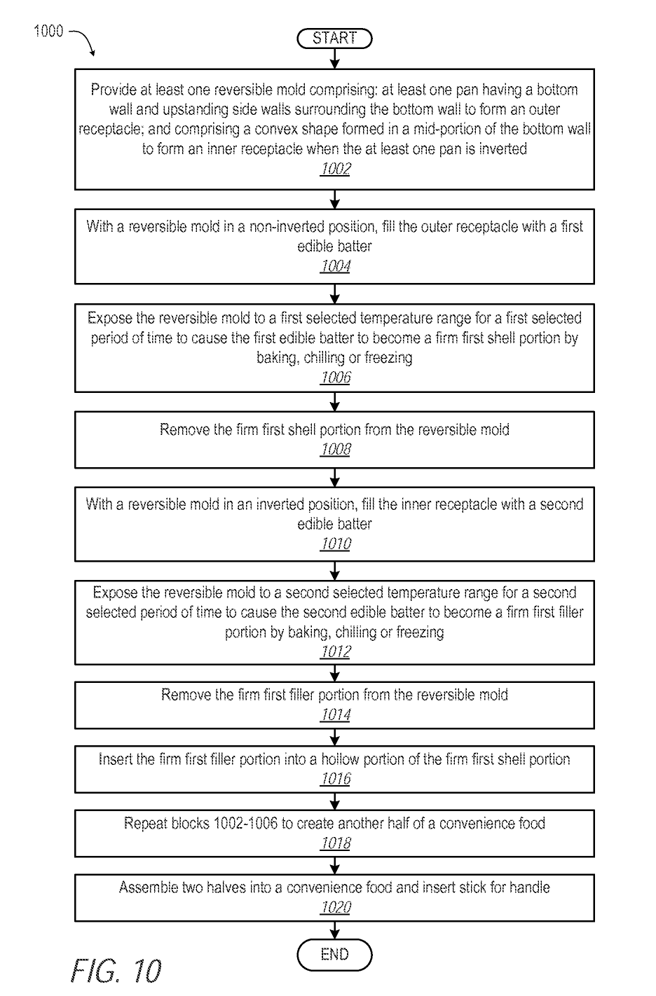

FIG. 10 illustrates a method 1000 for forming a convenience food. In one embodiment, the method 1000 includes providing at least one reversible mold comprising: at least one pan having a bottom wall and upstanding side walls surrounding the bottom wall to form an outer receptacle; and comprising a convex shape formed in a mid-portion of the bottom wall to form an inner receptacle when the at least one pan is inverted (block 1002). The method 1000 includes with a reversible mold in a non-inverted position, filling the outer receptacle with a first edible batter (block 1004). The reversible mold is exposed to a first selected temperature range for a first selected period of time to cause the first edible batter to become a firm first shell portion by baking, chilling or freezing (block 1006). The firm first shell portion is removed from the reversible mold (block 1008). At another time with the same reversible mold or contemporaneously with another reversible mold in an inverted position, the method 1000 includes filling the inner receptacle with a second edible batter (block 1010). The reversible mold is exposed to a second selected temperature range for a second selected period of time to cause the second edible batter to become a firm first filler portion by baking, chilling or freezing (block 1012). The firm first filler portion is removed from the reversible mold (block 1014). The method 1000 includes inserting the firm first filler portion into a hollow portion of the firm first shell portion to create half of a convenience food item with a contrasting center (block 1016). The contrasting center may include fruit (e.g., cherries, strawberries, apple pieces, raspberries, etc.), candies (e.g., chocolates, marshmallows, gummy worms, gumballs, etc.), nuts (e.g., walnuts, almonds, cashews, etc.), or the like. In some embodiments, if the contrasting material is, for example, a chocolate or a marshmallow, the contrasting material may melt during baking to create a creamy or gooey center.

In one embodiment, the first shell portion is made of cake with thousands of small air pockets. When surrounding a frozen contrasting center made of materials such as ice cream, custard, sorbet, sherbet and the like, the resulting confection is self-insulating and may be consumed without fast melting. In one embodiment, the first shell portion is made of a cake batter, preferably an angel food cake batter, the bulk of which constitutes aerated egg or egg whites having a large plurality of minute air cells therein. In one embodiment, the first shell portion is made of batter comprising a substantial amount of aerated egg or egg whites to possess thousands of tiny air cells therein distributing throughout the batter, and baking the batter to thereby produce a light, fluffy cake having air pockets therein. The cake is preferably formed using a conventional batter subjected to aeration. Aeration refers to the process of introducing a gas, such as air, into a liquid or viscous solution. In one embodiment, the aeration is achieved using eggs, specifically whole eggs and egg whites. Aeration can be by one or more methods selected from aeration incorporated into the batter during mixing, the addition of beaten whole egg, the addition of baking powder, baking soda or other gas producing composition to produce gas in the batter, using heat to cause the liquid in the batter to turn to steam, and the addition of carbonated water or another carbonated liquid such as beer to aerate the batter in some recipes.

Blocks 1002-1016 are repeated to create another half of the convenience food item (block 1018). The method 1000 includes assembling the firm first and second shell portion together with the firm first and second filling portions in contact to form the convenience food with the contrasting center. A stick can be inserted into the assembled convenience food with a contrasting center for eating on the go (block 1020).

In the above described flow chart of FIG. 10, the method may be embodied in an automated manufacturing system that performs a series of functional processes. In some implementations, certain steps of the methods are combined, performed simultaneously or in a different order, or perhaps omitted, without deviating from the scope of the disclosure. Thus, while the method blocks are described and illustrated in a particular sequence, use of a specific sequence of functional processes represented by the blocks is not meant to imply any limitations on the disclosure. Changes may be made with regards to the sequence of processes without departing from the scope of the present disclosure. Use of a particular sequence is therefore, not to be taken in a limiting sense, and the scope of the present disclosure is defined only by the appended claims.

It must be noted that, as used in this specification and the appended claims, the singular forms “a,” “an” and “the” include plural referents unless the content clearly dictates otherwise. Thus, for example, reference to a “colorant agent” includes two or more such agents.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

As will be appreciated by one having ordinary skill in the art, the methods and compositions of the invention substantially reduce or eliminate the disadvantages and drawbacks associated with prior art methods and compositions.

It should be noted that, when employed in the present disclosure, the terms “comprises,” “comprising,” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

While it is apparent that the illustrative embodiments of the invention herein disclosed fulfill the objectives stated above, it will be appreciated that numerous modifications and other embodiments may be devised by one of ordinary skill in the art. Accordingly, it will be understood that the appended claims are intended to cover all such modifications and embodiments, which come within the spirit and scope of the present invention.

What is claimed is:

1. A reversible mold comprising:
a pan having a bottom wall and upstanding side walls surrounding the bottom wall to form an outer receptacle; and
a convex shape formed in a mid-portion of the bottom wall to form an inner receptacle when pan is inverted.

2. The reversible mold of claim 1, wherein the convex shape comprises a cylindrical shape that extends partially into the outer receptacle, the outer receptacle comprises an annular ring portion that surround the convex shape and comprises a cylindrical portion above the convex shape that communicates with the annular ring portion.

3. The reversible mold of claim 2, wherein the reversible mold comprises a baking pan.

4. The reversible mold of claim 3, wherein the reversible mold comprises a material that is tolerant of refrigeration and freezing.

5. A method for forming a convenience food, the method comprising:
providing at least one reversible mold comprising: at least one pan having a bottom wall and upstanding side walls surrounding the bottom wall to form an outer receptacle; and comprising a convex shape formed in a mid-portion of the bottom wall to form an inner receptacle when the at least one pan is inverted;
with a reversible mold in a non-inverted position, filling the outer receptacle with a first edible batter;
exposing the reversible mold to a first selected temperature range for a first selected period of time to cause the first edible batter to become a firm first shell portion;
removing the firm first shell portion from the reversible mold;
with a reversible mold in an inverted position, filling the inner receptacle with a second edible batter;
exposing the reversible mold to a second selected temperature range for a second selected period of time to cause the second edible batter to become a firm first filler portion;
removing the firm first filler portion from the reversible mold; and
inserting the firm first filler portion into a hollow portion of the firm first shell portion.

6. The method of claim 5, wherein one of the first and second selected temperature ranges comprises a baking temperature.

7. The method of claim 5, wherein one of the first and second selected temperature ranges comprises a chilling temperature.

8. The method of claim 5, wherein one of the first and second selected temperature ranges comprises a freezing temperature.

9. The method of claim 8, wherein the first selected temperature range comprises a baking temperature and the second selected temperature range comprises a freezing temperature.

10. The method of claim 5, further comprising:
forming a firm second shell portion with a reversible mold;
forming a firm second filler portion with a reversible mold;
inserting the second filler portion into a hollow portion of the firm second shell portion; and
assembling the firm first and second shell portion together with the firm first and second filling portions in contact to form a convenience food with a contrasting center.

11. The method of claim 9, further comprising inserting a stick into the assembled convenience food with a contrasting center.
